(19) United States
(12) Patent Application Publication
(10) Pub. No.: US 2010/0235900 A1
(43) Pub. Date: Sep. 16, 2010

(54) EFFICIENT TWO-FACTOR AUTHENTICATION

(75) Inventors: Mark Robinton, Somerville, MA (US); Scott B. Guthery, Chestnut Hill, MA (US)

Correspondence Address: SHERIDAN ROSS PC, 1560 BROADWAY, SUITE 1200, DENVER, CO, 80202, US

(73) Assignee: ASSA ABLOY AB, Stockholm (SE)

(21) Appl. No.: 12/716,845

(22) Filed: Mar. 3, 2010

Related U.S. Application Data
(60) Provisional application No. 61/160,193, filed on Mar. 13, 2009.

(51) Int. Cl. H04L 9/32

(52) U.S. Cl. 726/9; 713/159

(57) ABSTRACT

Methods, devices, and systems are provided for an efficient two-factor authentication process. In particular, a card challenge is combined with a user-provided password or similar user-based credential before a transformation of the data is performed. Once the combined challenge and user-provided credential have been transformed, the transformed data is used as a basis for authentication verification.

### CROSS-REFERENCE TO RELATED APPLICATIONS

This application claims the benefit of U.S. Provisional Application No. 61/160,193, filed Mar. 13, 2009, the entire disclosure of which is hereby incorporated herein by reference.

### FIELD OF THE INVENTION

The present invention relates generally to secure access networks and in particular authentication schemes within such networks.

### BACKGROUND

Integrated Circuit (IC) cards which currently utilize two-factor authentication require two independent command/response protocols with the IC card. There is one command/response authentication protocol to authenticate a terminal device being used to interact with the card and separate command/response authentication protocol to authenticate a person using the card.

There are card application contexts, such as contactless “tap-and-go” physical access and payment applications, where the total amount of time taken for all required command/response interactions with the card is critical. In other words, a certain amount of delay between presenting the card to the terminal and exchanging messages between the terminal and card is acceptable, but only up to a limited threshold. There are also card application contexts, such as network and mobile applications, where the total number of required command/response interactions with the card is critical. In other words, a certain number of message exchanges between the card and terminal are acceptable, but only up to a limited threshold.

In these two contexts, and others, the independent and time-sequential method of conducting the two authentication protocols provided by the current art is a disadvantage because of the total number of command/response interactions and because of the total amount of time needed for these command/response interactions. Stated another way, two-factor authentication is currently not achievable in many contexts due to the amount of time required and/or number of message exchanges required to achieve two-factor authentication with currently available techniques.

### SUMMARY

It is, therefore, one aspect of the present invention to provide an efficient two-factor authentication protocol as well as devices and systems for carrying out said protocol.

In accordance with at least some embodiments of the present invention, the authentication of a terminal device and the authentication of a cardholder or user are combined into one authentication protocol and one command/response interaction with the IC card.

One method of authenticating a terminal device to a card is to retrieve a random number called a challenge from the card and to return to the card a transformation of that challenge (e.g., encryption with a secret key of the random number), that can only be performed by terminals authorized to interact with the card. This authentication protocol is called EXTERNAL AUTHENTICATION. The following notation can be utilized to represent this EXTERNAL AUTHENTICATION protocol:
ExpectedResponse=Terminal(CardChallenge)

One method of authenticating a cardholder or user is to have the cardholder send to the card a secret password or other personal identification number (PIN) that is only known to individuals that are authorized to use the card. This authentication protocol is called VERIFY PIN. The following notation can be utilized to represent this VERIFY PIN protocol:
ExpectedPassword=Cardholder(EnteredPassword)

The sequential execution of these two authentication protocols is an example of the independent and time-sequential method of conducting two-factor authentication in the current art.

Embodiments of the present invention propose combining the terminal authentication protocol and the cardholder authentication protocol into a single authentication protocol, thereby resulting in a single command/response interaction between the card and terminal. The following notation can be utilized to represent a protocol utilized in accordance with at least some embodiments of the present invention:
ExpectedResponse=Terminal(CardChallenge⊕Cardholder(EnteredPassword))

In other words, the terminal is expected to combine, “⊕”, the card challenge with the entered password before performing the secret transformation on the result and returning the result to the card.

Since both the challenge and the password are known to the card, the card can also perform the combining operation, “⊕”, in order to verify the response received from the terminal (i.e., by comparing the internally generated transformation of the combined card challenge and entered password with the transformation received from the terminal).

In accordance with at least some embodiments of the present invention, the combining operation, “⊕”, is constructed so that the result of applying the terminal transformation to the combination of the challenge and the correct password is different from applying the terminal transformation to the combination of the challenge and any incorrect password.

When the terminal transformation is encryption with a secret key then an example of such a combining operation “⊕” is the exclusive OR (XOR) operation.

The combining operation, “⊕”, may also be constructed so that the result of applying the terminal transformation to the combination of the challenge and the correct password is different from applying the terminal transformation to the combination of the challenge and any incorrect password. Different terminal transformations as dictated by the card authentication protocol may require means of combining the challenge with the password other than the XOR operation. The XOR operation does, however, work with the most widely used method of EXTERNAL AUTHENTICATION; that is to say encryption with a cryptographic key.

In accordance with at least some embodiments of the present invention, an authentication method is provided that generally comprises:

receiving a card challenge;

receiving a user-provided credential;

combining the card challenge with the user-provided credential; and

transforming the combination of the card challenge and user-provided credential.

In some embodiments, the combining and transforming step may be performed at a terminal device, in which case the transformed combination may be sent to a card where it is compared to an authentication value calculated at the card.

In some embodiments, the combining and transforming step may be performed at a card, in which case the transformed combination may be compared to a result received from a terminal device.

In some embodiments, the combining and transforming steps are performed by both the terminal device and the card and either the card or an authentication server are employed to compare the results and verify authentication of the terminal device and cardholder.

In some embodiments, the cardholder provides the user-provided credential in the form of biometric data. Alternatively, or in combination, the cardholder provides the user-provided credential in the form of a PIN. The user-provided credential may be provided before the card is presented to the terminal or after the card is presented to the terminal without departing from the scope of the present invention.

The Summary is neither intended nor should it be construed as being representative of the full extent and scope of the present invention. The present invention is set forth in various levels of detail and the Summary as well as in the attached drawings and in the detailed description of the invention and no limitation as to the scope of the present invention is intended by either the inclusion or non inclusion of elements, components, etc. in the Summary. Additional aspects of the present invention will become more readily apparent from the detailed description, particularly when taken together with the drawings.

### BRIEF DESCRIPTION OF THE DRAWINGS

FIG. 1 depicts a communication system in accordance with embodiments of the present invention;

FIG. 2 is a diagram depicting data flows in a first exemplary authentication method in accordance with embodiments of the present invention;

FIG. 3 is a diagram depicting data flows in a second exemplary authentication method in accordance with embodiments of the present invention;

FIG. 4 is a diagram depicting data flows in a third exemplary authentication method in accordance with embodiments of the present invention;

FIG. 5 is a diagram depicting data flows in a fourth exemplary authentication method in accordance with embodiments of the present invention;

FIG. 6 is a diagram depicting data flows in a fifth exemplary authentication method in accordance with embodiments of the present invention; and

FIG. 7 is a flow chart depicting an exemplary authentication method in accordance with embodiments of the present invention.

### DETAILED DESCRIPTION

Embodiments of the invention will be illustrated below in conjunction with an exemplary communication system. Although well suited for use with, e.g., a system using computers, servers, and other computing devices, the invention is not limited to use with any particular type of computing or communication device or configuration of system elements. Those skilled in the art will recognize that the disclosed techniques may be used in any application in which it is desirable to provide increased security via heightened authentication requirements.

The exemplary systems and methods of this invention will also be described in relation to analysis software, modules, and associated analysis hardware. However, to avoid unnecessarily obscuring the present invention, the following description omits well-known structures, components and devices that may be shown in block diagram form that are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

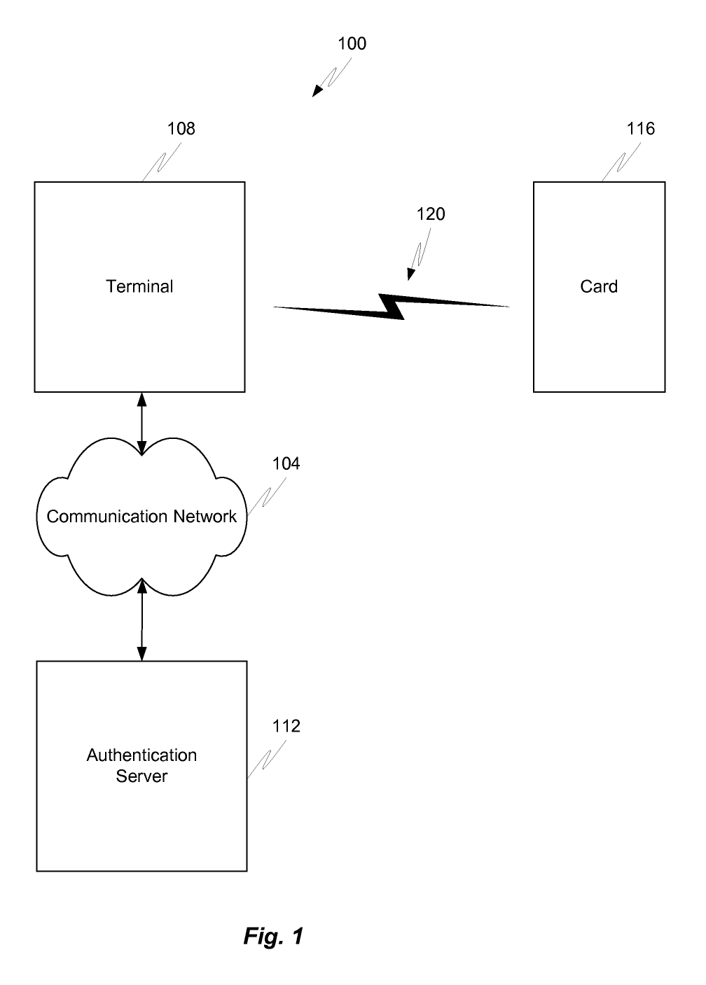

Referring initially to FIG. 1, details of a communication system 100 are depicted in accordance with at least some embodiments of the present invention. The communication system 100 generally includes a communication network 104 providing one or more communication channels between a terminal device 108 and an authentication server 112. The terminal device 108 is also capable of communicating with a card 116 via a second communication link 120. In some embodiments, the communication link 120 is independent of and separate from the communication network 104.

Although card 116 may be embodied as an actual identification card or more particularly an RFID card, one skilled in the art will appreciate that the card 116 may be provided in different other form factors. For example, the card 116 may be provided as an Integrated Circuit Card (ICC), a key fob, a mobile phone utilizing NFC, a Personal Digital Assistant (PDA), a laptop, or any other portable electronic device comprising memory sufficient to store at least an identifier of the card 116. The card 116 may also be adapted to store other types of information that can be used to authenticate either the card 116 or a holder of the card 116.

In accordance with at least some embodiments of the present invention, the communication network 104 is adapted to carry messages between the components connected thereto. Thus, the terminal device 108 sends messages to and receives messages from the authentication server 112 via the communication network 104. The communication network 104 may comprise any type of known communication network including wired and wireless or combinations of communication networks and may span long or small distances. The protocols supported by the communication network 104 include, but are not limited to, the TCP/IP protocol, Wi-Fi, Wiegand Protocol, RS 232, RS 485, RS422, Current Loop, F2F, Bluetooth, Zigbee, GSM, SMS, optical, audio and so forth. The Internet is an example of the communication network 104 that constitutes a collection of IP networks consisting of many computers and other communication devices located locally and all over the world. The devices may are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular communication network, a satellite communication network, any type of enterprise network, and any other type of packet-switched or circuit-switched network known in the art. It can be appreciated that the communication network 104 need not be limited to any one network type, and instead may be comprised of a number of different networks and/or network types.

The communication link 120 may be a wired and/or wireless communication link. In some embodiments, the communication link is completely contactless. Such an embodiment may utilize Radio Frequency (RF) signals to establish the communication link 120, in which case the terminal 108 and card 116 may both comprise RF communication interfaces (e.g., an RF antenna) thereby facilitating the transmission and reception of RF signals. The terminal 108 and card 116 may also comprise modulation/demodulation units for formatting electrical signals and messages consistent with an agreed upon format. Such modulation/demodulation units may be in communication with the interfaces of the devices or may be integral to the interfaces of the devices.

Other contact-based communication links 120 may also be utilized without departing from the scope of the present invention. In particular, a magnetic communication interface (e.g., a magnetic stripe on the card 116 and magnetic stripe reader on the terminal 108) may be utilized to facilitate communications between the two devices.

Other types of communication links 120 include, without limitation, an optical communication interface (e.g., an infrared detector and transmitter on one or both of the card 116 and terminal 108), an electrical contact communication interface (e.g., electrical contacts provided on the card 116 and terminal 108), or any other means of communicating information to/from a card 116.

As can be appreciated by those skilled in the art, it may be possible to eliminate the terminal 108, in which case a communication link is established directly between the authentication server 112 and card 116. Other system reconfigurations will also become readily apparent to those skilled in the art based on the present disclosure.

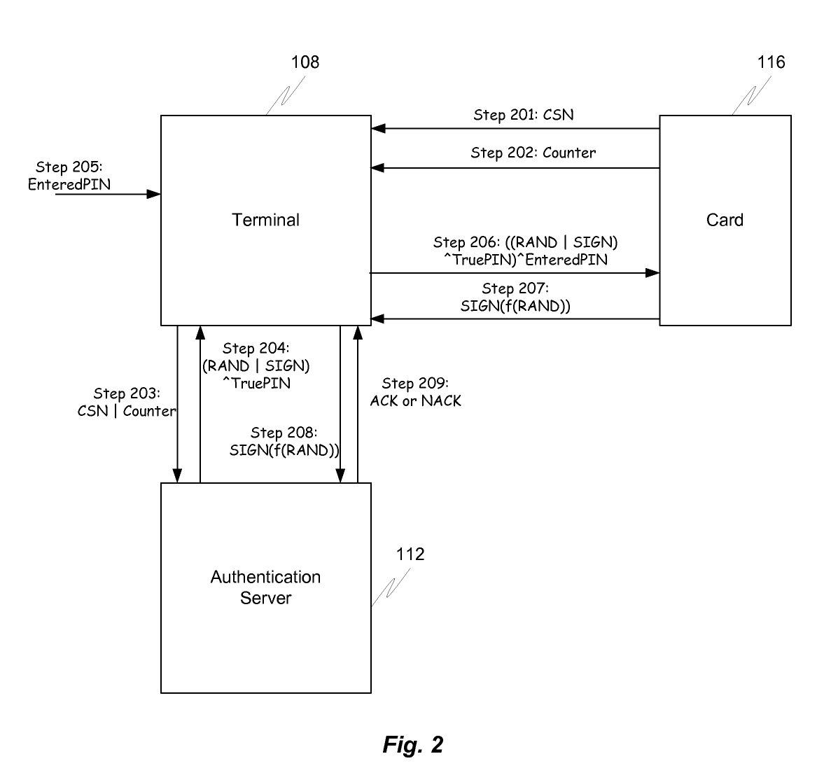

Referring now to FIG. 2, a first exemplary authentication method will be described in accordance with at least some embodiments of the present invention. The method is initiated when a Card Serial Number (CSN) or similar identifier of the card 116 is provided to the terminal 108 via communication link 120 (Step 201). Either concurrent with Step 201, before step 201, or after step 201, a counter number is provided from the card 116 to the terminal 108 (Step 202). As can be appreciated by those skilled in the art, the counter may be implemented as a simple integer counting value (e.g., 0, 1, 2, 3, etc.) that represents a count of actions being maintained at the card 116.

The CSN and/or counter are then provided from the terminal 108 to the authentication server 112 (Step 203). The CSN and/or counter may be viewed as a challenge sent from the card 116 to the authentication server 112 via the terminal 108. The authentication server 112 may then utilize one or both of the CSN and counter value to determine a TruePIN (Personal Identification Number) associated with the holder of the card 116 (i.e., a previously stored PIN assigned to or chosen by a holder of the card 116 and maintained in a secure area, such as memory in or available to the authentication server 112). The determined TruePIN can then be transformed (e.g., encrypted with a secret key determined based on a random number, the CSN, the counter, or any other value known to the authentication server 112) and provided back to the terminal 108 (Step 204).

Before or after Step 201, 202, 203, or 204, a user enters an EnteredPIN at the terminal in an attempt to authenticate the holder of the card 116 to the terminal 108 (Step 205). The terminal 108 is then capable of combining the EnteredPIN with the encrypted TruePIN received from the authentication server 112 and provide the combined result to the card 116 (Step 206). In accordance with at least some embodiments of the present invention, the combining of the user authentication data (i.e., the EnteredPIN) and the card authentication data (i.e., the results obtained from the authentication server 112 based on the CSN and/or counter) may be performed in a variety of ways. In some embodiments, the user authentication data and card authentication data is combined according to an XOR function. Any other type of combining operation may be used which is constructed so as to generate a result that would be different if the combining operation were applied to valid user authentication data and invalid card authentication data or vice versa.

The card 116 receives the combined result from the terminal 108 and computes a signature value, SIGN, that is a function of the combined result received from the terminal 108. The computed signature value is provided to the terminal (Step 207), which then forwards the signature to the authentication server 112 (Step 208). The authentication server 112 then compares the signature received from the card 116 with a signature computed internally based on the CSN, counter, random number, and/or TruePIN. Assuming that both signatures were computed with the same numbers and with the same combining and/or encryption algorithms, then the signatures will match in which case the authentication server 112 can generate an authentication affirmation signal, ACK, which is transmitted to the terminal 108 such that the terminal 108 can perform actions consistent with receiving the ACK from the authentication server 112 (Step 209). As can be appreciated by one skilled in the art, actions which may be taken consistent with receipt of an ACK include, without limitation, unlocking a door, engaging a switch, removing a block to a computer program, application, or account, or otherwise removing a barrier protecting a tangible or intangible asset.

If, however, the signature received from the card 116 does not match the internally calculated signature, then the authentication server 112 is not able to generate an ACK and will instead generate a NACK, or do nothing, which will cause the terminal 108 to either do nothing or present the card holder with an access rejected message.

It should be noted that neither the TruePIN nor any other sensitive data is exposed on the terminal 108. Additionally, the actual CSN and TruePIN may be maintained in the authentication server 112 in an encrypted format with a master encryption key. Moreover, in some embodiments, the TruePIN may be up to eight bytes or eight ASCII characters in length.

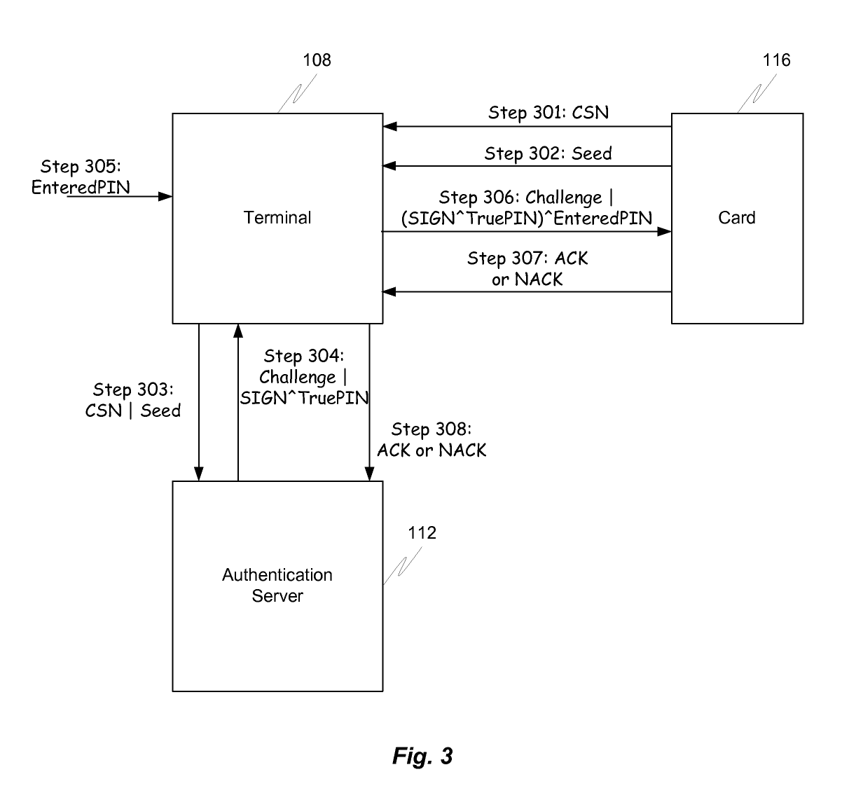

Referring now to FIG. 3, a second exemplary authentication method will be described in accordance with at least some embodiments of the present invention. The method is initiated when a card 116 provides a CSN and seed value to the terminal 108 (Steps 301 and 301). These steps may be performed simultaneously or sequentially, in no particular order. The seed value may correspond to any predetermined integer or non-integer value that is known by or available to the card 116.

Thereafter, the terminal 108 provides the CSN and seed value received from the card 116 to the authentication server 112 (Step 303). The authentication server 112 generates a challenge that is a combination of a signature value and a TruePIN for the card 116. The TruePIN and/or signature for the challenge are generally determined based on the CSN and/or seed value as the input. This challenge value is provided to the terminal (Step 304). The challenge value represents the data which can be used to authenticate the card 116 (i.e., card authentication data).

The terminal 108 is also adapted to receive a user-authenticating credential (e.g., an EnteredPIN) (Step 305). The terminal 108 then generates a value that is a combination of the challenge and the EnteredPIN. In other words, the terminal 108 combines the user authentication data and the card authentication data to produce a combined, two-factor authentication. In some embodiments, the user authentication data and card authentication data are produced with an XOR function.

The combination of the card authentication data and user authentication data is then provided to the card 116 (Step 306). The card 116 is then capable of comparing the received combination with an expected combination. In other words, an authentication decision reflecting an authentication of the user and an authentication of the terminal 108/server 112 to the card 116 is made on the card 116. The results of this authentication decision generate either an acknowledgement signal (ACK) or a non-acknowledgement signal (NACK), which is transmitted back to the terminal 108 (Step 307). This signal may then be acted upon by the terminal 108 consistent with the ACK or NACK, or the terminal may provide the ACK or NACK signal to the authentication server 112 for the execution of an action consistent with the signal (Step 308).

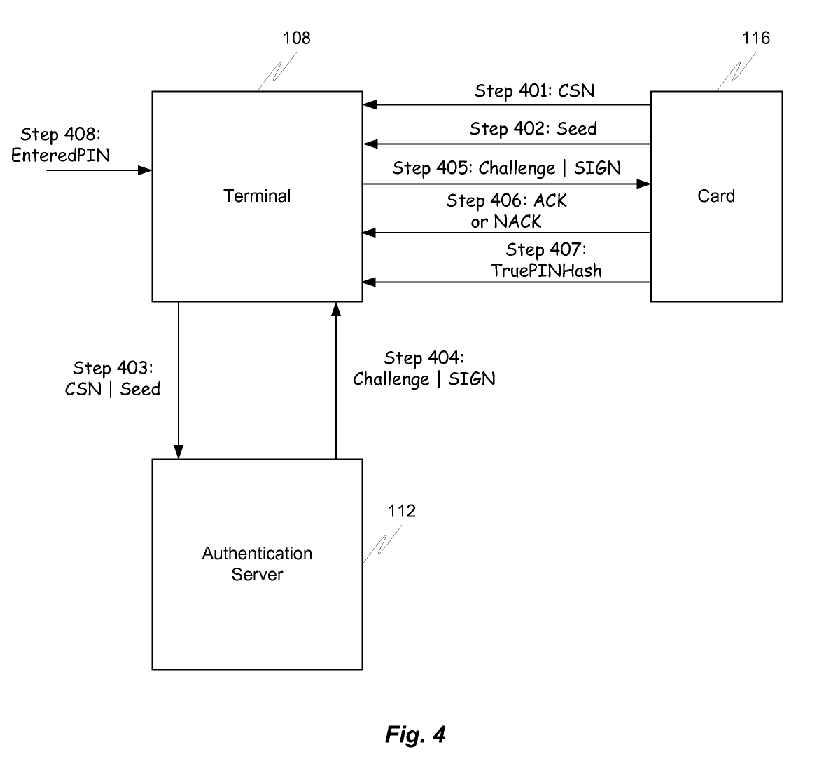

With reference now to FIG. 4, a third exemplary authentication method will be described in accordance with at least some embodiments of the present invention. The method is initiated when a CSN and seed value are provided by the card 116 to the terminal 108 (Steps 401 and 402). These steps may be performed simultaneously or sequentially, in no particular order. The CSN and seed value are then provided to the authentication server 112 (Step 403). The authentication server 112 then generates a challenge value based on the received CSN and seed value, where the challenge represents card authentication data. The challenge is provided back to the terminal 108 (Step 404), which subsequently forwards the challenge to the card 116 (Step 405).

The card 116 compares the challenge with an expected response to the challenge and, in the event that a match between the received challenge and the expected challenge is confirmed, the card 116 generates an ACK. Otherwise, the card 116 generates a NACK. The resultant ACK/NACK is provided back to the terminal 108 (Step 406). In addition to providing the ACK/NACK for the comparison of card authentication data, the card 116 is capable of retrieving a TruePIN value from internal memory and generating a hash value of the TruePIN value. Any type of known hash function may be utilized to generate the hash of the TruePIN value. This hash value is then forwarded to the terminal 108 (Step 407).

Before or after Step 407, a user enters a PIN (EnteredPIN) at the terminal 108 (Step 408). The terminal 108 then generates a hash value of the EnteredPIN value, resulting in an EnteredPINHash value. The terminal 108 then compares the EnteredPINHash value with the TruePINHash value to authenticate the user. If the PINHash values match, and the terminal 108 received an ACK in Step 406, then the terminal 108 is allowed to perform one or more actions consistent with authenticating both the card 116 and a holder of the card 116.

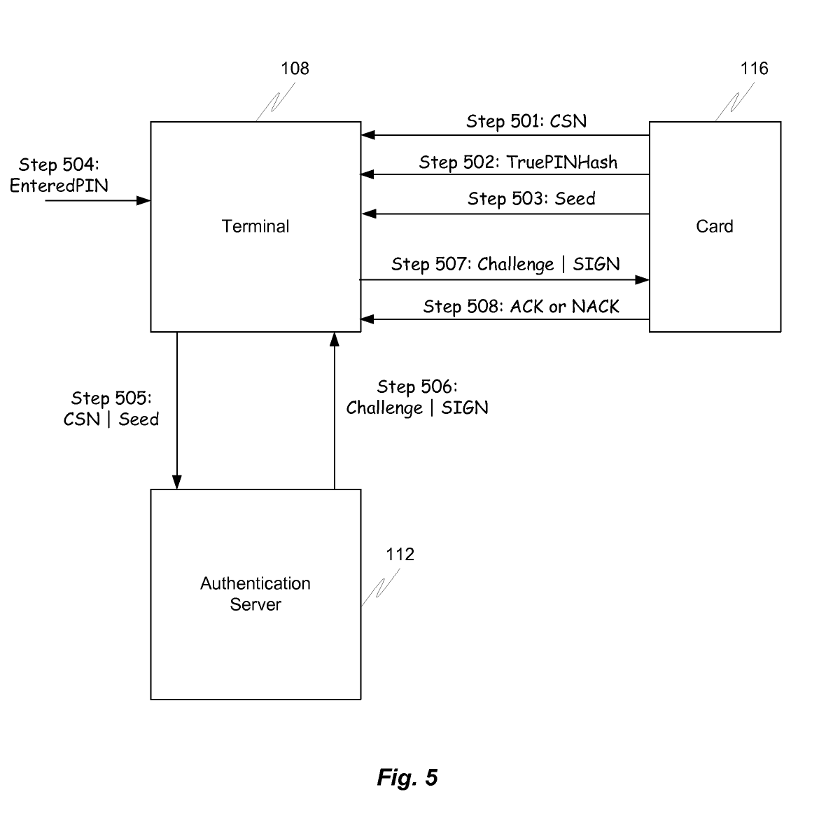

Referring now to FIG. 5, a fourth exemplary authentication method will be described in accordance with at least some embodiments of the present invention. The method is initiated when a CSN, TruePINHash, and seed value are provided by the card 116 to the terminal 108 (Steps 501, 502, and 503). These steps may be performed simultaneously or sequentially, in no particular order. In some embodiments, the TruePINHash value may be calculated only after one or both of Step 501 and 503 are performed.

The terminal 108 then receives an EnteredPIN from the holder of the card 116, thereby providing user authentication data to the terminal 108 (Step 504). The terminal 108 is then adapted to create an EnteredPINHash based on the EnteredPIN (e.g., by using the EnteredPIN as an input to a predetermined hash function) and compare the EnteredPINHash with the TruePINHash. If the two values match, then the terminal 108 determines that the user authentication data is valid. Verification of the card authentication data, however, remains to be determined. Accordingly, the terminal 108 forwards the CSN and seed value to the authentication server 112 (Step 505), which causes the authentication server 112 to generate a challenge based on the CSN and/or seed value. The challenge value is provided back to the terminal 108 (Step 506), which forwards the challenge to the card 116 (Step 507). The card 116 is then capable of comparing the challenge value with an expected challenge value, thereby resulting in an authentication decision for the card authentication data. Results of this authentication decision for the card authentication data are then provided back to the terminal 108 (Step 508) in the form of an ACK or NACK, such that the terminal 108 is allowed to perform an action consistent with the receipt of the ACK or NACK and also consistent with the validation of the user authentication data.

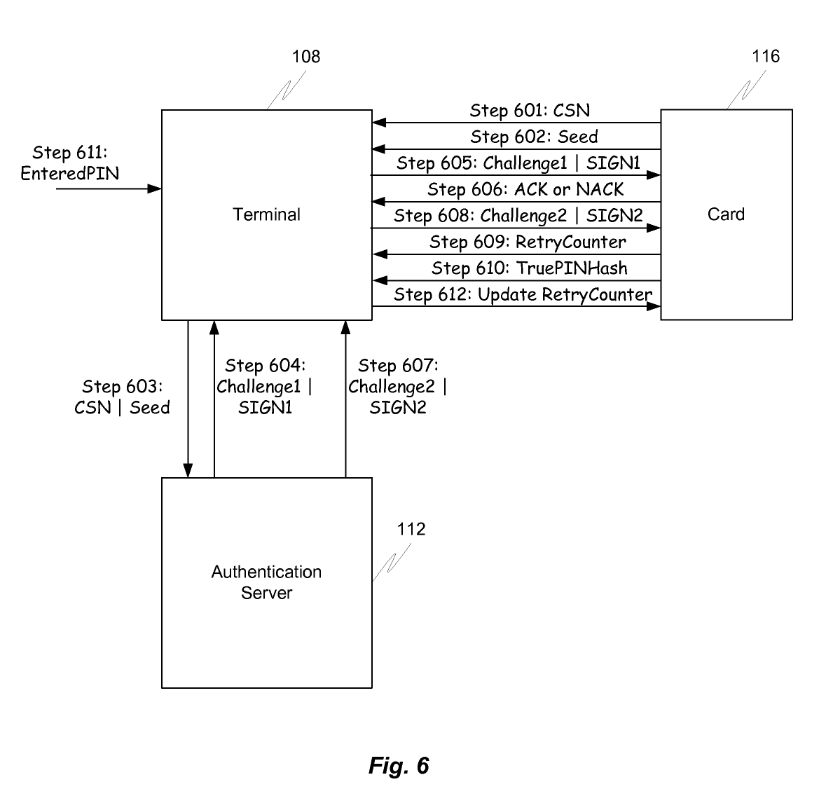

Referring now to FIG. 6, a fifth exemplary authentication method will be described in accordance with at least some embodiments of the present invention. The method is initiated when a CSN and seed value are provided from the card 116 to the terminal 108 (Steps 601 and 602). These steps may be performed simultaneously or sequentially, in no particular order.

Thereafter, the CSN and/or seed value are provided from the terminal 108 to the authentication server 112 (Step 603), where the authentication server 112 generates a first challenge based on one or more of the CSN, seed value, and the like. The first challenge may be provided back to the terminal (Step 604). The authentication server 112 may also be capable of generating a second challenge which can be computed similarly to the first challenge, may be identical to the first challenge, or may differ from the first challenge in that a different input was utilized to generate the second challenge (Step 607). The generation and transmission of the second challenge may be simultaneous with or subsequent to the generation and transmission of the first challenge. In other words, the authentication server 112 may be adapted to compute the first and second challenges at substantially the same time and transmit the first and second challenges in the same message that is transmitted to the terminal 108.

Upon receiving the first challenge, the terminal 108 forwards the challenge to the card 116 (Step 605). The card 116 can then analyze the first challenge and compare its value to an expected value. If the first challenge received from the terminal 108 matches the expected value, then the card 116 generates an ACK. Otherwise the card 116 generates a NACK. The first ACK or NACK, reflecting results of the card 116 validating or failing to validate the card authentication data contained in the first challenge, is then transmitted back to the terminal 108 (Step 606).

Upon receiving the second challenge, the terminal 108 forwards the challenge to the card 116 (Step 608). The card 116 then transmits a RetryCounter to the terminal 108 (Step 609). The RetryCounter may include an integer number that counts the number of interactions between the card 116 and the terminal 108 or any other component of the system 100. Transmission of the RetryCounter may be dependent upon the received second challenge matching an expected value of the second challenge.

Simultaneous to one or both of Steps 606 and 609, or after one or both of Steps 606 and 608, the card 116 may also provide to the terminal 108 a TruePINHash that is a hash value of the true pin known and/or created by the rightful and expected holder of the card 116 (Step 610).

Simultaneous to one or more of Steps 606, 609, and 610, or after one or more of Steps 606, 609, and 610, the terminal 108 receives an EnteredPIN from the actual holder of the card 116 (Step 611). The terminal 108 is then able to calculate a hash value on the EnteredPIN to produce an EnteredPINHash, which can be compared to the TruePINHash. If the EnteredPINHash value matches the TruePINHash value, then the terminal 108 verifies the user authentication data of the EnteredPIN and, depending upon whether a proper ACK and RetryCounter value have been received, the terminal 108 verifies the card authentication data and performs one or more steps in accordance with such verifications or determinations.

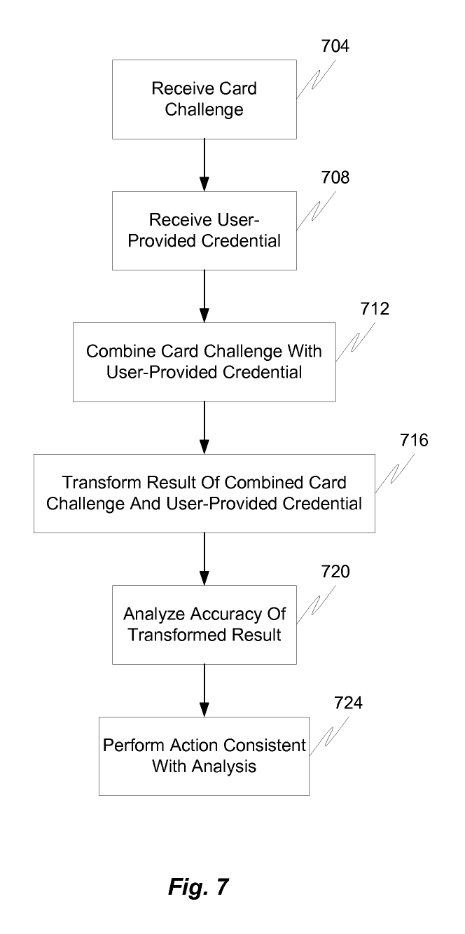

Referring now to FIG. 7, an exemplary authentication method will be described in accordance with at least some embodiments of the present invention. The method is initiated when a card challenge (i.e., card authentication data) is received at a first authenticating entity (e.g., card 116, authentication server 112, or terminal 108) (Step 704). The card challenge may include any type of identification or authentication information that substantially uniquely identifies a card that is engaging in a communication session with one or both of a terminal 108 and authentication server 112. Exemplary types of card identification information which may be included in the card challenge or which may be utilized to generate the card challenge include, without limitation, a CSN, seed value, counter value, site code, or the like.

Following receipt of the card challenge, or possibly before receipt of the card challenge, a user-provided credential (i.e., user authentication data) is received at the first authenticating entity (Step 708). The user-provided credential may include a PIN that has been entered at a keypad provided on the terminal 108, authentication server 112, or card 116. Other types of user-provided credentials include, without limitation, a fingerprint scan, a retinal scan, a facial scan, a voice sample, or any other amount of information that can be utilized to authenticate a user of the card.

Once the first authenticating entity has control of the user-provided credential and the card challenge, the first authenticating entity is capable of combining the card challenge with the user-provided credential in a substantially unique way (Step 712). In some embodiments, the first authenticating entity combines the card challenge and user-provided credential via an XOR operation.

The combined result is then transformed with a secret transformation algorithm (Step 716). This step may include encrypting the combined result with an encryption algorithm which utilizes an encryption key. Other transformations which may be utilized include check-sums, hashes, and other transforming operations.

The transformed result is then provided from the first authenticating entity to a second authenticating entity (e.g., card 116, authentication server 112, or terminal 108). The first authenticating entity and second authenticating entity may comprise two different devices, at least one of which needs to verify the identity of the other and a holder of the device before allowing additional communications to occur. As an example, the first authenticating entity may comprise a terminal 108 and the second authenticating entity may comprise a card 116 and the terminal 108 needs to confirm an identity of the card 116 and a holder of the card 116 before allowing further communications to ensue. Conversely, a card 116 may want to verify that the terminal 108 is allowed to communicate with the card 116 and the card 116 also wants to verify that it is currently being held by the proper user of the card.

Upon receiving the transformed result at the second authenticating entity, the second authenticating entity compares the received transformed result with an expected transformed result to analyze the accuracy of the received transformed result (Step 720). In some embodiments, the received transformed result is compared to an expected transformed result. In some embodiments, the received transformed result is modified (e.g., un-transformed or further transformed) and compared with an expected modified result.

If the received transformed result matches the expected transformed result, then the second authenticating entity is capable of making an affirmative authenticating decision regarding the user authentication data and the card authentication data. If the received transformed result does not match the expected transformed result, then the second authenticating entity determines that one or both of the user authentication data and card authentication data are invalid. The second authenticating entity performs one or more actions consistent with the results of the analysis (Step 724). Such actions may include releasing an asset for user access, allowing further communications between the first and second authenticating entities, restricting access to an asset, restricting further communications, or doing nothing.

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described access control equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as TPM, PLD, PLA, FPGA, PAL, a communications device, such as a server, personal computer, any comparable means, or the like. In general, any device capable of implementing a state machine that is in turn capable of implementing the methodology illustrated herein can be used to implement the various data messaging methods, protocols and techniques according to this invention.

Furthermore, the disclosed methods may be readily implemented in software. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the computer arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an integrated circuit card applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for increasing the efficiency of two-factor authentication schemes. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. An authentication method, comprising:
receiving a card challenge;
receiving a user-provided credential;
combining the card challenge with the user-provided credential; and
transforming the combination of the card challenge and user-provided credential.

2. The method of claim 1, wherein the user-provided credential includes one or more of a PIN, a fingerprint scan, a facial scan, a retinal scan, and a voice sample.

3. The method of claim 2, wherein the card challenge includes or is calculated based on one or more of a card identification number, a card serial number, a seed value, a counter value, and a site code.

4. The method of claim 3, wherein combining the card challenge with the user-provided credential comprises calculating an XOR value of the card challenge and the user-provided credential and wherein transforming the combination of the card challenge and user-provided credential comprises encrypting the calculated XOR value with a secret encryption key to create a transformed value.

5. The method of claim 4, further comprising:
providing the transformed value from a first authenticating entity which performed the combining and transforming steps to a second authenticating entity;
comparing, by the second authenticating entity, the transformed value with an expected transformed value; and
subsequent to the comparing step, applying the following rule set:
in the event that the transformed value matches the expected transformed value, permitting a holder of the first or second authenticating entity to access an asset secured by the other of the first or second authenticating entity; and
in the event that the transformed value does not match the expected transformed value, restricting a holder of the first or second authenticating entity to access an asset secured by the other of the first or second authenticating entity.

6. The method of claim 5, wherein, in the event that the transformed value matches the expected transformed value, the second authenticating entity authenticates both the first authenticating entity and a holder of the first or second authenticating entity at substantially the same time.

7. The method of claim 5, wherein the second authenticating entity comprises a card and wherein the first authenticating entity comprises one of a terminal and authentication server.

8. The method of claim 7, wherein the card comprises one or more of an RFID, an ICC, a key fob, a mobile phone, and a PDA.

9. A secure access system, comprising:
a card being assigned to an authorized card holder and being carried by an actual card holder;
a terminal adapted to communicate with the card via a communication link, wherein one or both of the card and terminal are adapted to verify an authenticity of the other of the card and terminal as well as verify that the actual card holder is the authorized card holder by analyzing a combined authentication value that includes a combination of card authentication information and user authentication information, wherein the card authentication information is obtained from the card, wherein the user authentication information is obtained from the actual card holder, and wherein the combined authentication value comprises a single number that was calculated based on the card authentication information and the user authentication information.

10. The system of claim 9, wherein the user authentication information includes one or more of a PIN, a fingerprint scan, a facial scan, a retinal scan, and a voice sample.

11. The system of claim 10, wherein the card authentication information includes or is calculated based on one or more of a card identification number, a card serial number, a seed value, a counter value, and a site code.

12. The system of claim 11, wherein the combined authentication value comprises an XOR value calculated based on the card authentication information and the user authentication information.

13. The system of claim 12, wherein the combined authentication value is further encrypted with a secret encryption key and transferred from one of the card and terminal to the other of the card and terminal for analysis.

14. The system of claim 13, wherein one or both of the card and terminal are capable of applying the following rule set based on an analysis of the combined authentication value:
in the event that the combined authentication value, or an encryption thereof, matches an expected value, permitting the actual card holder to access an asset secured by the terminal; and
in the event that the combined authentication value, or an encryption thereof, does not match the expected value, restricting the actual card holder to access an asset secured by the terminal.

15. The system of claim 9, wherein the card comprises one or more of an RFID, an ICC, a key fob, a mobile phone, and a PDA.

16. A computer program product comprising computer executable instructions stored onto a computer readable medium which, when executed by a processor of a computer, cause the processor to execute a method, the method comprising:
receiving card authentication information;
receiving user authentication information;
determining a combined authentication value by combining the card authentication information with the user authentication information; and
transmitting the combined authentication value to one of a card and terminal such that the combined authentication value, or a transformation thereof, can be analyzed by an analyzing device, thereby enabling the analyzing device to confirm a trusted relationship exists between the card and terminal and an actual holder of the card is an authorized holder of the card.

17. The method of claim 16, wherein the card comprises the analyzing device.

18. The method of claim 16, wherein the terminal comprises the analyzing device.

19. The method of claim 16, further comprising:
encrypting the combined authentication value with a secret encryption key prior to transmission of the combined authentication value to one of the card and terminal.

20. The method of claim 16, wherein the user authentication information includes one or more of a PIN, a fingerprint scan, a facial scan, a retinal scan, and a voice sample, wherein the card authentication information includes or is calculated based on one or more of a card identification number, a card serial number, a seed value, a counter value, and a site code, and wherein the combined authentication value comprises an XOR value calculated based on the card authentication information and the user authentication information.
